(19) United States
(12) Patent Application Publication
(10) Pub. No.: US 2018/0276713 A1
(43) Pub. Date: Sep. 27, 2018

(54) DEVICE WITH NFC TAG AND SYSTEM USING THE DEVICE

(71) Applicant: ENUKANTO CO, LTD., Tokyo (JP)

(72) Inventor: Kigen Nozawa, Tokyo (JP)

(21) Appl. No.: 15/829,522

(22) Filed: Dec. 1, 2017

(30) Foreign Application Priority Data
Mar. 27, 2017 (JP) 2017-060562
Jun. 20, 2017 (JP) 2017-120255

(51) Int. Cl. G06Q 30/02; H04B 5/00

(52) U.S. Cl. CPC G06Q 30/0257; G06Q 30/0267; H04B 5/0056

(57) ABSTRACT

A system using a sales promotion object for performing display of a product or sales promotion of the product, and an NFC tag that is provided in the sales promotion object, automatically activates a portable information terminal by near field communication (NFC) when a customer holds a portable information terminal including at least a reader among a reader and a writer of the NFC tag, and causes the portable information terminal to access to a word-of-mouth information site of the product of which an address is stored in advance in a tag storage unit through an internet line in an activated state.

Priority is claimed to Japanese Patent Application Nos. 2017-060562 filed on Mar. 27, 2017 and 2017-120255 filed Mar. 27, 2017, the entire contents of which, including the specifications, the claims and the drawings, are incorporated herein by reference in their entirety.

### TECHNICAL FIELD

The present invention relates to a sales promotion object with an NFC tag and a sales promotion system of performing display of a product or sales promotion of the product by being installed at a product displaying place or the like of a store.

### BACKGROUND OF THE INVENTION

It is known that IC chips are attached to all product displayed in a fixture, product information such as a production place is stored in a memory unit of the IC chip, and the product information is displayed on a display such as a smartphone (portable information terminal). In addition, it is known that, by attaching the IC chip to a commodity display hook displayed in a state where a plurality of product is suspended, it is possible to provide each advertisement information of the displayed product group at a low price and to stimulate the willingness of customers to purchase.

### SUMMARY OF THE INVENTION

The present invention is a system using a sales promotion object for performing display of a product or sales promotion of the product, and an NFC tag that is provided in the sales promotion object, automatically activates a portable information terminal by near field communication when a customer holds a portable information terminal including at least a reader among a reader and a writer of the NFC tag, and causes the portable information terminal to access to a word-of-mouth information site of the product of which an address is stored in advance in a tag storage unit through an internet line in an activated state.

### BRIEF DESCRIPTION OF DRAWINGS

FIG. 1 is a perspective view illustrating a use state of a sales promotion object with an NFC tag according to Example 1 of the invention.

FIG. 2 is a block diagram of an electric system configuring a part of the sales promotion object with an NFC tag according to Example 1 of the invention.

FIG. 3A is a front view of a page on which first information is posted on a word-of-mouth information site of a product automatically displayed on a display of a portable information terminal by the NFC tag.

FIG. 3B is a front view of a page of second information automatically displayed on the display.

FIG. 3C is a front view of a page of third information automatically displayed on the display.

FIG. 4 is a perspective view illustrating a fixture as the sales promotion object with an NFC tag according to Example 1 of the invention.

FIG. 5 is a perspective view illustrating a product hanger panel as the sales promotion object with an NFC tag according to Example 1 of the invention.

FIG. 6 is a perspective view illustrating a counter display as the sales promotion object with an NFC tag according to Example 1 of the invention.

FIG. 7 is an overall configuration diagram of a system according to Example 2 of the invention.

### DETAILED EXPLANATION OF THE INVENTION

According to this invention, in a store, when a customer holds a portable information terminal over an NFC tag attached to a sales promotion object, a reader reads information stored in a tag storage unit through near field communication, and the portable information terminal automatically starts based on an instruction from the NFC tag. Moreover, the portable information terminal automatically accesses a word-of-mouth information site of the product stored in the tag storage unit in advance through an internet line, and displays a site screen thereof on a display.

With this, it is possible to provide word-of-mouth information of a user on the product written in the word-of-mouth information site in real time in the store to the customer who is interested in the product. In addition, the customer can also write the appearance of the product, the impression of taking the product, and the like in the word-of-mouth information site.

A type of product is arbitrary as long as it can be sold in the store. For example, the type of product may be cosmetics, foods, drinks, clothing product, household electric appliances, cooking utensils, miscellaneous product, medicines, medical product, health equipment, luxury goods, sports product, stationery, books, gardening tools, tools, pet supplies, furniture, bedding, and the like.

Here, the sales promotion object (digital quick pop) includes a display tool for displaying the product and a sales promotion tool for promoting the sales promotion of the product.

Here, for example, as the portable information terminal, it is possible to adopt a portable terminal such as a smartphone and a tablet. However, the portable information terminal must be equipped with both a reader and writer for reading the NFC tag or only with the reader. Needless to say, the portable information terminal includes a display for displaying information of the word-of-mouth information site on a screen.

A near field communication (NFC) tag is a radio frequency identification (RFID) for performing the near field communication within a few meters. The NFC tag includes an antenna, an NFC communication unit including a high-frequency circuit, the tag storage unit of a ROM or a RAM, a control unit incorporating a CPU, and a power receiving unit of a power supply circuit.

The word-of-mouth information site of the product is managed by a management server (including cloud server) connected to the internet line, and contents are stored in a database thereof.

An operator of the word-of-mouth information site is arbitrary. For example, the operator may be a manufacturer of the product, a sales company of product affiliated with the manufactures, and various stores (for example, supermarkets, department stores, shopping malls, individual stores, or the like) that sell the product at the store.

The sales promotion system is one of sales promotion service for enhancing product purchasing power of the customer (member) at a store, and gives an electronic point as a reward to a contributor (member) who posts the word-of-mouth information on the word-of-mouth information site.

Both the customer and the contributor to the word-of-mouth information are members who complete membership registration of the store. The number of members is arbitrary, including the customer and the contributor. Generally, the customer and the contributor are generally different, but they may be the same person.

A membership data obtaining method by a membership data obtaining device or circuit is not limited. For example, the membership data may be obtained from a member side portable information terminal by using the NFC tag. In addition, the membership data stored in a predetermined membership card may be read by various card readers.

Product purchase data creating means is an electronic circuit that creates product purchase data by associating the membership data obtained by the membership data obtaining device or circuit with sales data of the product when the customer purchases the product at a register of the store.

A register storage unit for storing the product purchase data may be provided in the register.

Evaluation inputter is a device for causing the customer to perform the high evaluation or low evaluation with respect to the word-of-mouth information posted on the word-of-mouth information site. For example, the evaluation is performed by tapping a screen of the display of a member side portable information terminal, by inputting a key, or the like.

The word-of-mouth information site of the product is a database (data aggregation) configuring a website relating to the word-of-mouth information of the product provided on the server.

An electronic point giving circuit determines the word-of-mouth information of the contributor (member) as the high evaluation (first point giving condition) by operating the evaluation inputter by the customer (member) who purchases the product, and for transmitting a predetermined electronic point to the member side portable information terminal possessed by the contributor through the Internet only when product purchase data serving as a proof that the customer purchases the product is obtained (second point giving condition).

The electronic point referred to here is a point (electronic money and virtual currency) as an electronic reward. For example, it is possible to exchange a product, cashes, and other electronic points, or not.

### Example

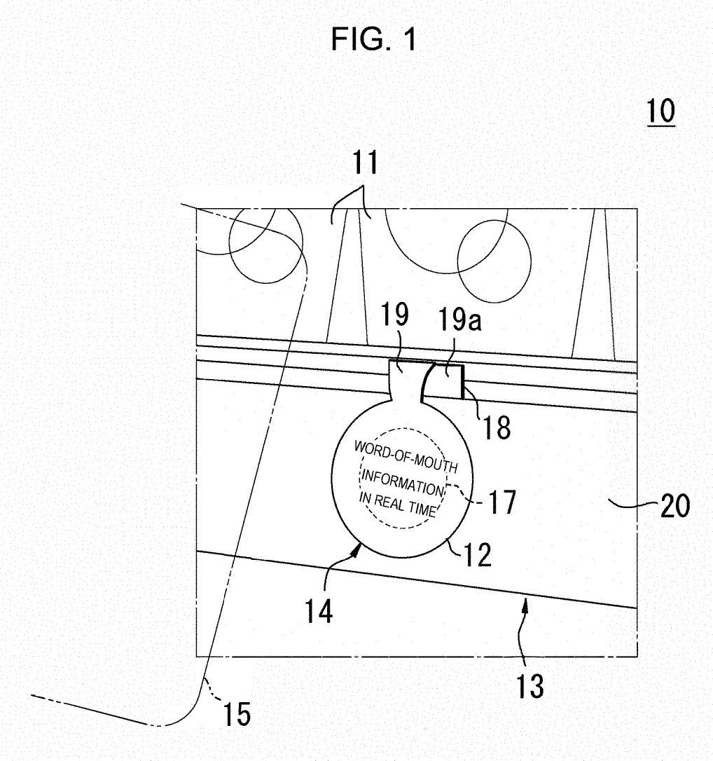

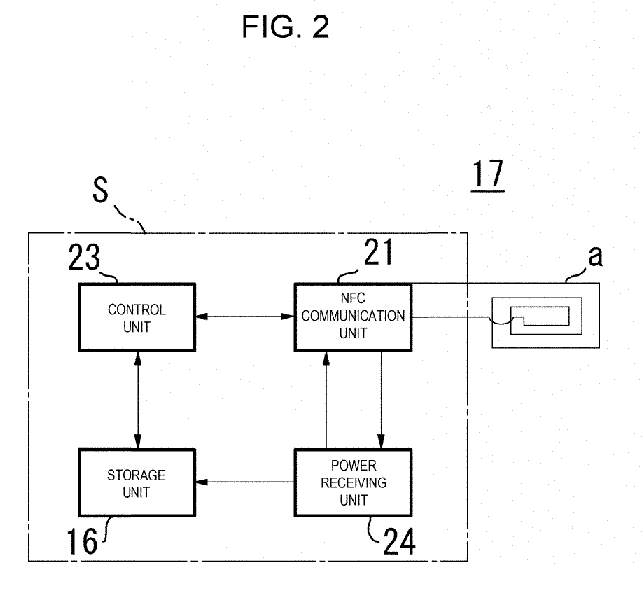

In FIG. 1 and FIG. 2, 10 is a sales promotion object with an NFC tag according to Example 1 of the invention. The sales promotion object with an NFC tag 10 causes an advertisement display section 12 of a shampoo (product) 11 to be displayed at a position away from a display shelf 13, and includes a swing POP (sales promotion object) 14 that gathers the interest of the customer by moving the advertisement display section 12 and an NFC tag 17 for the near field communication to access to the word-of-mouth information site (web site) of the shampoo 11 of the cloud server of which an address is stored in advance in a tag storage unit 16 through the internet line in an activated state automatically activated when the customer holds the smartphone (portable information terminal) 15 provided in the swing POP 14.

Hereinafter, these constituents will be specifically described.

The sales promotion object with an NFC tag 10 is the sales promotion object to which the NFC (near field communication) tag 17 is attached.

The swing POP 14 as the sales promotion object includes a circular advertisement display section 12 on a surface of which an advertisement of the shampoo 11 is printed and includes a T-shaped mounting portion 19 having a distal end integrally connected to a part of the periphery of the advertisement display section 12 in which a double-sided tape 18 adheres to a surface of a wide base end portion 19a.

The advertisement display section 12 and the mounting portion 19 are formed by die-cutting a thin synthetic resin sheet. The swing POP 14 is attached to the front edge surface of an uppermost shelf board 20 of the display shelf 13 by the double-sided tape 18 so as to be freely moved.

The NFC tag 17 is a radio frequency identification (RFID) tag of a near field communication technology with a frequency of 13.56 MHz standardized by ISO/IEC18092. The NFC tag 17 is operated with electric power supplied in a non-contact manner from a smartphone 15 having a reader and writer of the NFC tag 17, similar to a passive wireless tag.

As illustrated in diagrams FIG. 1 and FIG. 2, the NFC tag 17 is provided by disposing a spiral antenna a, an NFC communication unit 21, the tag storage unit 16, a control unit 23, and a power receiving unit 24 on a surface of a circular base sheet S consisting of a synthetic resin.

The NFC communication unit (high-frequency circuit) 21 is means for performing the near field communication with the smartphone 15 present in the vicinity (for example, several m).

The tag storage unit 16 is means for storing an address of the word-of-mouth information site of the shampoo 11.

The control unit 23 is means for incorporating a CPU and controlling the entire NFC tag 17.

The power receiving unit 24 including the power supply circuit is means for receiving electric power from the smartphone 15 in a non-contact manner through the NFC communication unit 21.

The smartphone 15 is a type of the portable information terminal, and includes a display 25 as a display unit and a reader and writer of the NFC tag 17 (not illustrated).

The cloud server is a server on a cloud (not illustrated) connected to the internet line, and operated by a manufacturer of the shampoo 11. The cloud server may be operated by a store not the manufacturer. Contents of the word-of-mouth information site of the shampoo 11 (website) are stored in the database (storage unit) of the cloud server.

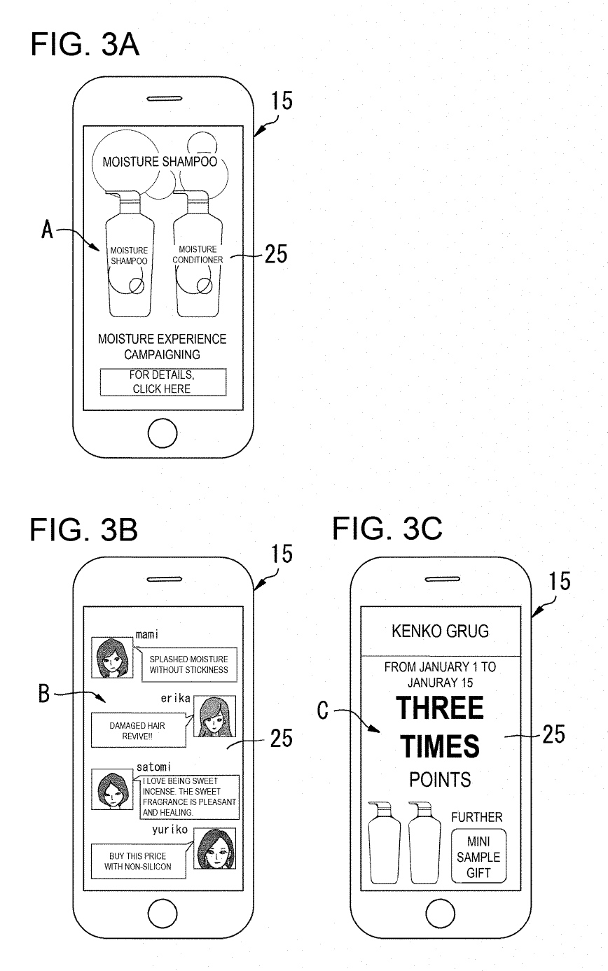

The word-of-mouth information site includes three contents. That is, on the front page, first information A consisting of “product information of the shampoo 11 and service information related to the shampoo 11” are posted (FIG. 3A). In addition, on the second page, “the word-of-mouth information of the shampoo 11” as second information B is posted (FIG. 3B). On the third page, “store information” of the third information C is posted (FIG. 3C).

Only the first information and the second information are posted on the word-of-mouth information site, the remaining third information may be stored in the tag storage unit 16, and may be transmitted to the smartphone 15 through the near field communication when the smartphone 15 is held over the NFC tag 17. With this configuration, even if only the product information and the word-of-mouth information of the shampoo 11 created by the manufacturer are posted on the word-of-mouth information site, by holding the smartphone 15 over the swing POP 14, it is possible to display the word-of-mouth information, the product information, and the store information on a screen of the display 25.

As the product information of the shampoo 11 here, it is possible to mention an ingredient table, product characteristics, a use method, a manufacturing company, a sales company, and the like.

In addition, as the service information related to the shampoo 11, there is an experience campaign of the shampoo 11 held by the manufacturer.

The word-of-mouth information of the shampoo 11 is an opinion on the feeling of use of a user who purchases the shampoo 11, the impression of the container and the package of the shampoo 11, the price, and the like.

In addition, the customer can also write in the word-of-mouth information site by using the possessed smartphone 15 about impressions, a container design, and the like when trying samples of the shampoo 11 in the store.

The store information here is an advertisement on a store side that sells the shampoo 11 such as electronic point-up day and bargain sale to be held next time at the store.

Next, with reference to FIG. 1 to FIG. 3C, a use method of the sales promotion object with an NFC tag 10 of the present invention will be described.

As described in FIG. 1 and FIG. 2, in the store, when the customer feels an interest in a specific shampoo 11 in front of the display shelf 13 of the shampoo 11, the customer holds the smartphone 15 over the swing POP 14. With this, the electric power transmitted through the near field transmission from the smartphone 15 is received by the power receiving unit 24 via the NFC communication unit 21 from the antenna a such that the NFC tag 17 is activated. That is, an address of the word-of-mouth information site of the shampoo 11 stored in the tag storage unit 16 is transmitted to the smartphone 15. With this, the smartphone 15 automatically accesses the word-of-mouth information site and displays a site page on the display 25.

When viewing the front page of the word-of-mouth information site, the customer first checks whether it is a desired shampoo 11, and if it is the desired one, the customer reads the product information of a manufacturer side which is the first information A posted on the front page (FIG. 3A). Next, the customer opens the second page and reads the word-of-mouth information (second information B) on which the feeling of use or the like of the user actually purchasing the shampoo 11 is posted (FIG. 3B).

Then, the customer determines whether or not to purchase the shampoo 11 with reference to the product information provided by the manufacturer side and the word-of-mouth information provided by a user side. Furthermore, the customer views the store information (third information C) such as electronic point-up day and advertisements of various bargains provided by the store side (FIG. 3C).

As described above, it is possible for the sales promotion object with an NFC tag 10 to provide the word-of-mouth information of users written in the word-of-mouth information site with respect to the shampoo 11 to the customer who is interested in the shampoo 11 in the store in a real time. In addition, the customer can also write comments on the packages and containers of the shampoo 11, impressions when trying the sample in the store, or the like from the smartphone 15 to the word-of-mouth information site.

These three pieces of information may be displayed on the display 25 with a predetermined order described above, and may be displayed at the same time by dividing a screen of the display 25 into three.

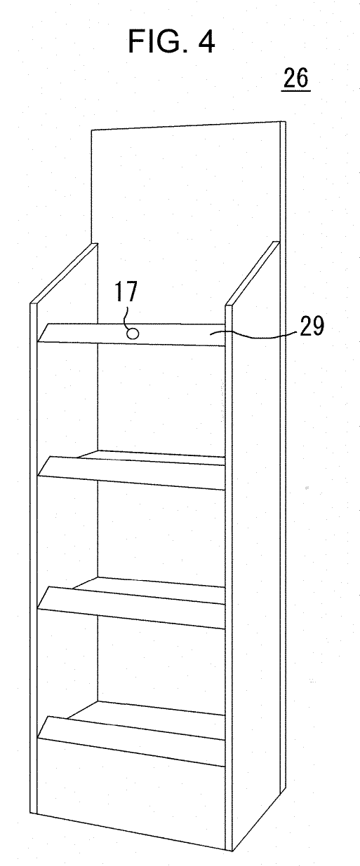

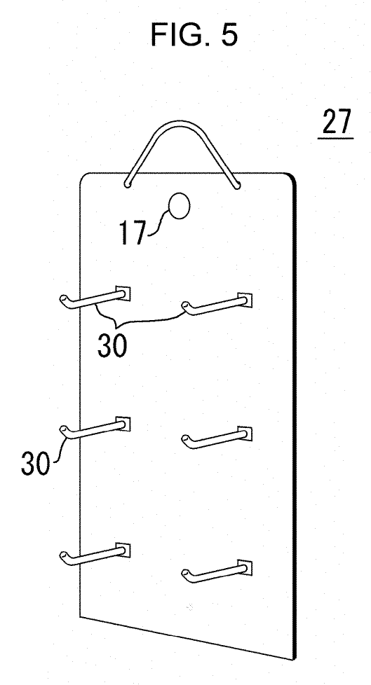

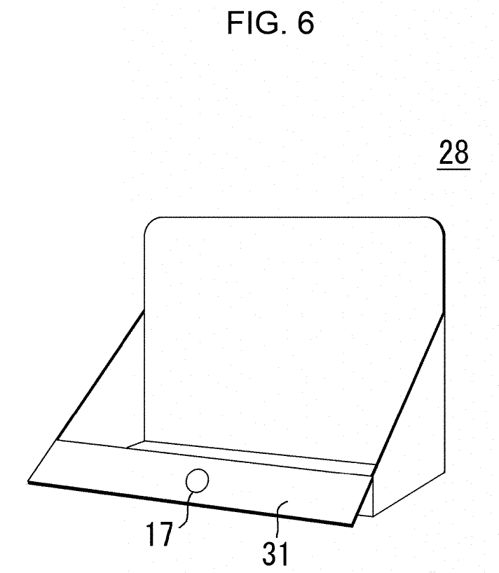

In addition, the NFC tag 17 may be attached to the swing POP 14, and may also be attached, for example, to a fixture 26 (see FIG. 4), a product hanger panel 27 (see FIG. 5), and a counter display 28 (see FIG. 6). An attachment position of each NFC tag 17 in these sales promotion objects 26 to 28 is set at the front central portion of the uppermost shelf board 29, the central portion of the upper end of a vertically elongated product hanger panel 27 from which six hooks 30 with three rows and two columns are projected, or the central portion of a front plate 31 of the counter display 28 in a vertically elongated fixture 26 of the four-step shelf type so as to facilitate a holding operation over the NFC tag 17 by the smartphone 15.

Furthermore, unlike the RFID, after the NFC tag is installed in the store, it is possible for the NFC tag to provide new information to the customer by changing the contents of the word-of-mouth information site even if the customer does not go to the store. In addition, by adopting the NFC tag, it is possible to perform writing and reading on smart media of which spread is expanding.

These types of information provided in the smartphone 15 can designate the scope of disclosure thereof. Specifically, it may be not only open to the public, but also the private release of only staff.

In addition, by adopting an access log, it is possible to know the number of accesses for stores, products, or the like.

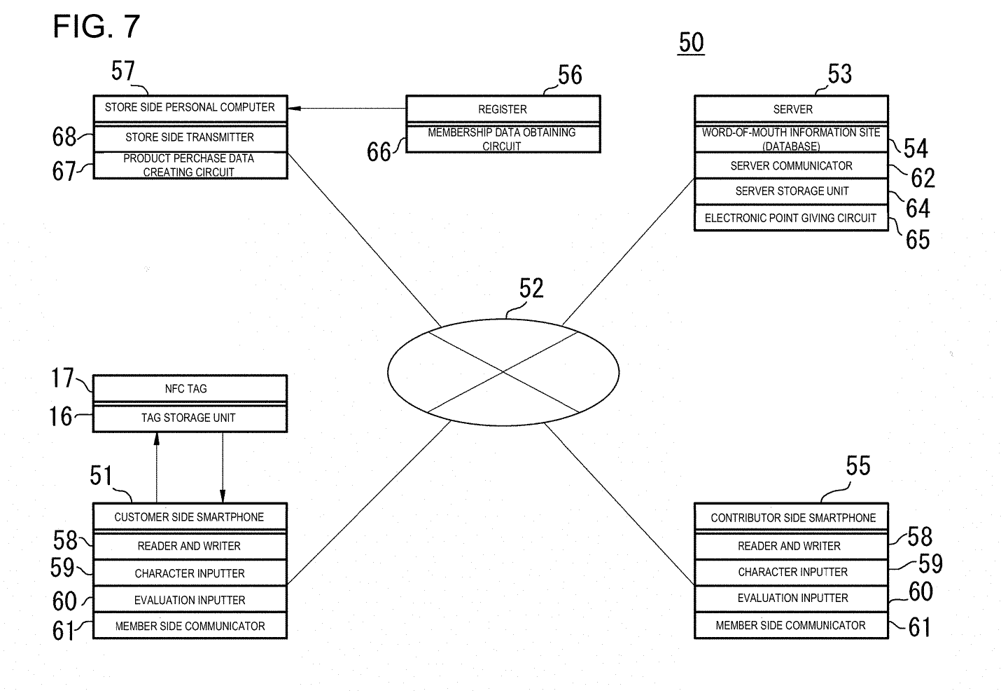

Next, with reference to FIG. 7, the sales promotion system according to Example 2 of the present invention will be described.

As described in FIG. 7, a sales promotion system 50 according to Example 2 of the present invention is a system which is accessed from a customer side smartphone (member side portable information terminal) 51 possessed by the customer who is a member of the store to the word-of-mouth information site (word-of-mouth information site of the product) 54 of the shampoo 11 managed by a server 53 by using an internet line 52, and transmits the electronic point from the server 53 to a contributor side smartphone (member side portable information terminal) 55 possessed by the contributor of the word-of-mouth information by using the internet line 52 in a case where the customer reads the word-of-mouth information posted by the contributor of another member and the shampoo 11 is purchased in the store as a read result of the high evaluation.

Hereinafter, the sales promotion system 50 will be described in detail.

The sales promotion system 50 includes the swing POP 14 with the NFC tag 17, the internet line 52, the customer side smartphone 51, the contributor side smartphone 55, the server 53, a register 56 installed in the store, and a store side personal computer (store side information terminal) 57 installed in an office of the store.

Hereinafter, these constituents will be described in detail.

The customer side smartphone 51 and the contributor side smartphone 55 include a reader and writer 58 for reading and writing information in the NFC tag 17 by using the near field communication, character inputter 59 for creating the word-of-mouth information to be posted on a word-of-mouth information site 54 by a member (contributor), evaluation inputter 60 for evaluating the word-of-mouth information to be posted on the word-of-mouth information site 54 by the member (customer), and member side communicator 61 that transmits post data from the character inputter 59 and a word-of-mouth evaluation signal from the evaluation inputter 60 to the server 53 through the internet line 52.

The server 53 includes server side communicator 62 that connects to the internet line 52, a word-of-mouth information site (database) 54 to which the word-of-mouth information is posted, a server storage unit 64 in which a mail address of each member side portable information terminal (including customer side smartphone 51 and contributor side smartphone 55) possessed by each member is stored, and electronic point giving circuit 65 from transmitting the electronic point from the server side communicator 62 to the contributor side smartphone 55 of which an address is obtained from the server storage unit 64 through the Internet line 52 when a word-of-mouth evaluation signal of the high evaluation and the product purchase data of the shampoo 11 are obtained from the internet line 52 through the server side communicator 62.

The register 56 is a cash register that records a result obtained by automatically calculating a sales amount of the product including the shampoo 11 purchased by the customer in the store. A card reader (membership data obtaining device or circuit) 66 that reads the membership data of the customer from the membership card to which a magnetic tape is attached is mounted in the register 56. The register 56 and a store side personal computer 57 are connected to each other so as to be able to perform data communication by a LAN cable.

In addition, the store side personal computer 57 includes product purchase data creating means or circuit 67 that creates the product purchase data by associating the membership data of the customer who purchases the shampoo 11 which is transmitted from the card reader 66 with the sales data of the shampoo 11 from the register 56, and a store side communicator or transmitter 68 that transmits the product purchase data to the server 53 through the internet line 52.

Next, with reference to FIG. 7, a sales promotion method of the product by the sales promotion system 50 according to Example 2 of the present invention will be described.

In the store, the customer holds the customer side smartphone 51 over the NFC tag 17 of the swing POP 14. With this, the customer side smartphone 51 is automatically activated based on an instruction from the NFC tag 17 using the near field communication. When the customer holds the customer side smartphone 51 over the NFC tag 17, the electronic point may be given to the customer side smartphone 51.

Then, the customer side smartphone 51 is automatically accessed to the word-of-mouth information site 54 of the shampoo 11 of which an address is stored in advance to the tag storage unit 16 through the internet line 52, and a site screen thereof is displayed on a display of the customer side smartphone 51.

The word-of-mouth information of the shampoo 11 created in advance by the contributor by using the character inputter 59 of the contributor side smartphone 55 is posted on the word-of-mouth information site 54 by the internet line 52 from the member side communicator 61.

The customer reads the word-of-mouth information of the contributor and a read result is evaluated by the evaluation inputter 60 such that the word-of-mouth evaluation signal is transmitted. The word-of-mouth evaluation signal is transmitted from the member side communicator 61 to the server 53 through the internet line 52. When the word-of-mouth evaluation signal is transmitted by the evaluation inputter 60, the customer may give the electronic point to the customer side smartphone 51.

In the server 53, the server side communicator 62 receives the word-of-mouth evaluation signal, and the received result is sent to the electronic point giving circuit 65. In a case where the received signal is the word-of-mouth evaluation signal of the high evaluation, the electronic point giving circuit 65 waits for a predetermined period of time whether the product purchase data arrives from the store side personal computer 57 (for example, one hour).

Hereinafter, a case where the word-of-mouth evaluation signal is processed as the high evaluation and the customer actually purchases the shampoo 11 in the store will be described.

In the register, the card reader 66 reads the membership data of the customer from the membership card presented by the customer. At this time, the electronic point may be given to the membership card. The read membership data is transmitted to the store side personal computer 57 through a LAN cable together with the sales data of the shampoo 11 obtained from the register 56 immediately thereafter.

In the store side personal computer 57, the product purchase data creating means or circuit 67 creates the product purchase data by associating the membership data of the customer who purchases the shampoo 11 with the sales data of the shampoo 11. The obtained product purchase data is transmitted from the store side transmitter 68 to the server 53 through the internet line 52.

In the server 53, the server side communicator 62 receives the product purchase data, and sends the received product purchase data to the electronic point giving circuit 65. With this, in the electronic point giving circuit 65, the customer processes the word-of-mouth evaluation signal of the high evaluation and the product purchase data with respect to the shampoo 11 purchased in the store by reading the word-of-mouth information. When these two conditions are processed, the electronic point giving circuit 65 issues the electronic point. The issued electronic point is given from the server side communicator 62 to the contributor side smartphone 55 on which the word-of-mouth information is posted through the internet line 52.

As described above, by posting the word-of-mouth information of the high evaluation that motivates the customer to be a member of a store so as to purchase the shampoo 11 on the word-of-mouth information site 54, even if the member himself/herself does not manage a blog, there is a possibility that the electronic point is automatically given. Meanwhile, a store side (manufacturer side and sales company side) can obtain high-quality word-of-mouth information. Furthermore, with new store owner affiliate using the NFC tag 17 and the word-of-mouth information site 54 of the shampoo 11, it is possible to simultaneously perform the sales promotion of the shampoo 11, acquisition of a new store member, and securing of loyal customers.

The sales promotion object with an NFC tag and the sales promotion system of the present invention which is installed in a product displaying place of the store or the like, and performs the sales promotion of the product are a useful technology.

It should be understood that the invention is not limited to the above-described embodiment, but may be modified into various forms on the basis of the spirit of the invention. Additionally, the modifications are included in the scope of the invention.

1. A sales promotion system comprising:
a sales promotion object for performing display of a product or sales promotion of the product;
an NFC tag provided in the sales promotion object;
a register;
a product purchase data creating circuit;
a store side information terminal; and
a store side transmitter,
wherein the NFC tag
includes a storage unit that stores an address of a word-of-mouth information site of the product,
is configured to automatically activate a portable information terminal by near field communication, and
is configured to cause the portable information terminal to access to a server that provides the word-of-mouth information site of a product of the address through an internet line in an activated state,
the register includes
a membership data obtaining circuit,
the membership data obtaining circuit obtains membership data of a customer who purchases the product by a wireless, wired, or manual input,
the product purchase data creating circuit creates product purchase data by associating the membership data with sales data of the product,
the store side transmitter that transmits the product purchase data to the server through the internet line, the portable information terminal includes
a reader and writer that reads and writes the address,
a character inputter that creates word-of-mouth information to be posted on the word-of-mouth information site of the product by a contributor of a member,
an evaluation inputter that performs an evaluation on the word-of-mouth information when posted on the word-of-mouth information site of the product by the customer of the member, and
a member side communicator that receives the word-of-mouth information posted on the word-of-mouth information site of the product from the server through the internet line, and transmits the word-of-mouth information from the character inputter and a word-of-mouth evaluation signal from the evaluation inputter to the server, and
the server includes
a server side communicator that connects to the internet line,
the word-of-mouth information site of the product,
a server storage unit that stores a mail address of a member side portable information terminal, and
an electronic point giving circuit that causes to transmit an electronic point from the server side communicator to the member side portable information terminal possessed by the member of the contributor of the word-of-mouth information of which an address is obtained from the server storage unit through the internet line, when the server side communicator receives the word-of-mouth evaluation signal of high evaluation and the product purchase data, through the internet line.
